(19) United States
(12) Patent Application Publication
(10) Pub. No.: US 2024/0095558 A1
(43) Pub. Date: Mar. 21, 2024

(54) INFORMATION PROCESSING APPARATUS, INFORMATION PROCESSING METHOD, AND PROGRAM

(71) Applicant: NEC Corporation, Tokyo (JP)

(72) Inventors: Yuta HATAKEYAMA, Tokyo (JP); Yuzuru OKAJIMA, Tokyo (JP)

(73) Assignee: NEC Corporation, Tokyo (JP)

(21) Appl. No.: 18/221,120

(22) Filed: Jul. 12, 2023

(30) Foreign Application Priority Data
Sep. 20, 2022 (JP) 2022-149300

(51) Int. Cl. G06N 7/01; G06N 20/00

(52) U.S. Cl. CPC G06N 7/01; G06N 20/00

(57) ABSTRACT

An information processing apparatus of the present disclosure includes: a region dividing unit that divides an instance input space of each of a plurality of machine learning models into a plurality of regions and assigns a probability to each of the division regions; a probability calculating unit that calculates a sampling probability on a predetermined instance belonging to the division region based on the probability assigned to the division region; and an instance selecting unit that selects the predetermined instance based on the sampling probability on the predetermined instance.

### INCORPORATION BY REFERENCE

This application is based upon and claims the benefit of priority from Japanese patent application No. 2022-149300, filed on Sep. 20, 2022, the disclosure of which is incorporated herein in its entirety by reference.

### TECHNICAL FIELD

The present disclosure relates to an information processing apparatus, an information processing method, and a program.

### BACKGROUND ART

As a model built by machine learning, there is a rule-based machine learning model as described in Patent Literature 1. Then, in order to improve the accuracy of a rule-based machine learning model, active learning is performed. In active learning, an unlabeled instance with uncertain prediction of a model is selected, labeled, and added to training instances, and the model is retrained using the training instances.
Patent Literature 1: Japanese Unexamined Patent Application Publication No. JP-A 2020-198041

However, in the active learning mentioned above, an instance close to the determination boundary tends to be intensively added to the training instances, so that the training instances are biased against the distribution. As a result, there arises a problem that the accuracy of a rule-based machine learning model cannot be improved. Moreover, such a problem can arise not only in a rule-based machine learning model but also in every kind of machine learning model.

### SUMMARY OF THE INVENTION

Accordingly, an object of the present disclosure is to provide an information processing apparatus that can solve the abovementioned problem that the accuracy of a machine learning model cannot be improved.

An information processing apparatus as an aspect of the present disclosure includes: a region dividing unit that divides an instance input space of each of a plurality of machine learning models into a plurality of regions and assigns a probability to each of the division regions; a probability calculating unit that calculates a sampling probability on a predetermined instance belonging to the division region based on the probability assigned to the division region; and an instance selecting unit that selects the predetermined instance based on the sampling probability on the predetermined instance.

Further, an information processing method as an aspect of the present disclosure includes: dividing an instance input space of each of a plurality of machine learning models into a plurality of regions and assigning a probability to each of the division regions; calculating a sampling probability on a predetermined instance belonging to the division region based on the probability assigned to the division region; and selecting the predetermined instance based on the sampling probability on the predetermined instance.

Further, a computer program as an aspect of the present disclosure includes instructions for causing a computer to execute processes to: divide an instance input space of each of a plurality of machine learning models into a plurality of regions, and assign a probability to each of the division regions; calculate a sampling probability on a predetermined instance belonging to the division region based on the probability assigned to the division region; and select the predetermined instance based on the sampling probability on the predetermined instance.

With the configurations as described above, the present disclosure can improve the accuracy of a machine learning model.

### BRIEF DESCRIPTION OF DRAWINGS

FIG. 1 is a block diagram showing a configuration of an information processing apparatus in a first example embodiment of the present disclosure;

FIG. 2 is a view showing processing by the information processing apparatus disclosed in FIG. 1;

FIG. 3 is a view showing processing by the information processing apparatus disclosed in FIG. 1;

FIG. 4 is a view showing processing by the information processing apparatus disclosed in FIG. 1;

FIG. 5 is a view showing processing by the information processing apparatus disclosed in FIG. 1;

FIG. 6 is a view showing other processing by the information processing apparatus disclosed in FIG. 1;

FIG. 7 is a flowchart showing operation of the information processing apparatus disclosed in FIG. 1;

FIG. 8 is a block diagram showing a hardware configuration of an information processing apparatus in a second example embodiment of the present disclosure; and

FIG. 9 is a block diagram showing a configuration of the information processing apparatus in the second example embodiment of the present disclosure.

### EXAMPLE EMBODIMENT

### First Example Embodiment

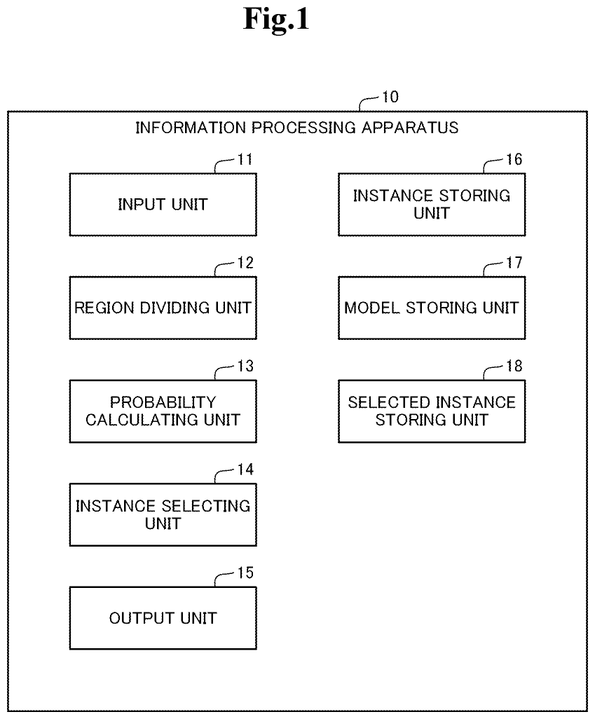

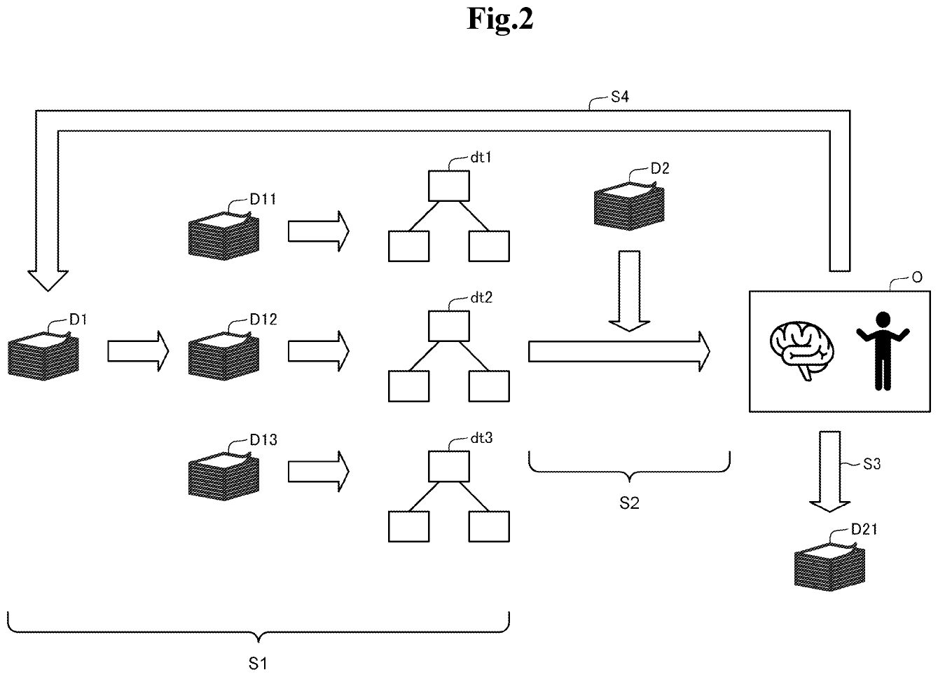

A first example embodiment of the present disclosure will be described with reference to FIGS. 1 to 7. FIG. 1 is a view for describing a configuration of an information processing apparatus, and FIGS. 2 to 7 are views for describing processing operation of the information processing apparatus.

### [Configuration]

An information processing apparatus 10 in this example embodiment is preferable to selection of an unlabeled instance with good training efficiency for the purpose of improving the accuracy of a machine learning model built by machine learning. In this example embodiment, as a machine learning model to be trained, a rule-based machine learning model that outputs a prediction value from an input value by a decision tree or a decision list will be described as an example. However, a machine learning model targeted by the information processing apparatus 10 of the present disclosure may target any machine learning model, not limited to the rule-based machine learning model.

The information processing apparatus 10 is configured by one or a plurality of information processing apparatuses each including an arithmetic logic unit and a memory unit. As shown in FIG. 1, the information processing apparatus 10 includes an input unit 11, a region dividing unit 12, a probability calculating unit 13, an instance selecting unit 14, and an output unit 15. The functions of the input unit 11, the region dividing unit 12, the probability calculating unit 13, the instance selecting unit 14, and the output unit 15 can be realized by the arithmetic logic unit executing a program for realizing the respective functions stored in the memory unit. The information processing apparatus 10 also includes an instance storing unit 16, a model storing unit 17, and a selected instance storing unit 18. The instance storing unit 16, the model storing unit 17, and the selected instance storing unit 18 are configured by the memory unit. Below, the respective components will be described in detail with reference to views showing processing in FIGS. 2 to 5. FIG. 2 is a view showing the overview of overall processing by the information processing apparatus 10.

The input unit 11 accepts input of a dataset including a set of training instances D1 previously provided with correct labels and, as indicated by symbol S1 in FIG. 2, generates a plurality of sets of training instances D11, D12 and D13 from the set of training instances D1 and stores into the instance storing unit 16. Here, the input unit 11 generates the plurality of sets of training instances D11, D12 and D13 by duplicated sampling from the set of training instances D1, for example. However, the input unit 11 is not necessarily limited to generating a plurality of sets of training instances from one set of training instances, but may acquire a plurality of sets of training instances generated in advance. Moreover, the number of the plurality of sets of training instances is not limited to three shown in FIG. 2, but may be any number.

Subsequently, as indicated by symbol S1 in FIG. 2, the input unit 11 learns the respective sets of training instances D11, D12, and D13 to generate a plurality of machine learning models dt1, dt2, and dt3, and stores into the model storing unit 17. Here, the input unit 11 generates a machine learning model that outputs a prediction value from an input value by a decision tree or a decision list, but may generate a machine learning model with any configuration. Moreover, the number of machine learning models to be generated is not limited to three shown in FIG. 2, but may be any number.

Although the plurality of machine learning models dt1, dt2, and dt3 are generated from the training instances D1 inputted in and accepted by the input unit 11 as described above in this example embodiment, a plurality of machine learning models dt1, dt2, and dt3 generated in advance may be stored into the model storing unit 17.

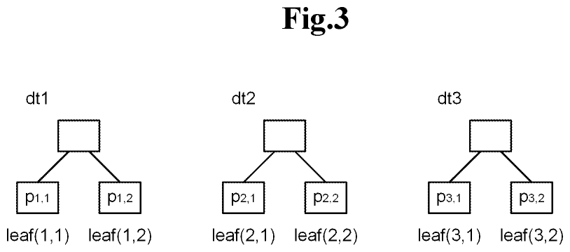

The region dividing unit 12 divides, in each of the machine learning models dt1, dt2 and dt3, an input space for an instance to be an input value to the machine learning model into a plurality of regions. Here, an example of the machine learning models dt1, dt2 and dt3 is shown in FIG. 3. In a case where the machine learning model is formed of a decision tree, the division regions of an instance input space are predicted values (predicted labels) by the decision tree, and correspond to the respective leaf nodes when the decision tree is graphically represented. For example, as shown in FIG. 3, two leaf nodes leaf(1,1) and leaf(1,2) are the division regions in the machine learning model dt1, two leaf nodes leaf(2,1) and leaf(2,2) are the division regions in the machine learning model dt2, and two leaf nodes leaf(3,1) and leaf(3,2) are the division regions in the machine learning model dt3. In a case where the machine learning model is formed of a decision list, a series of conditions (antecedents) based on the decision list correspond to the division regions, namely, the leaf nodes described above.

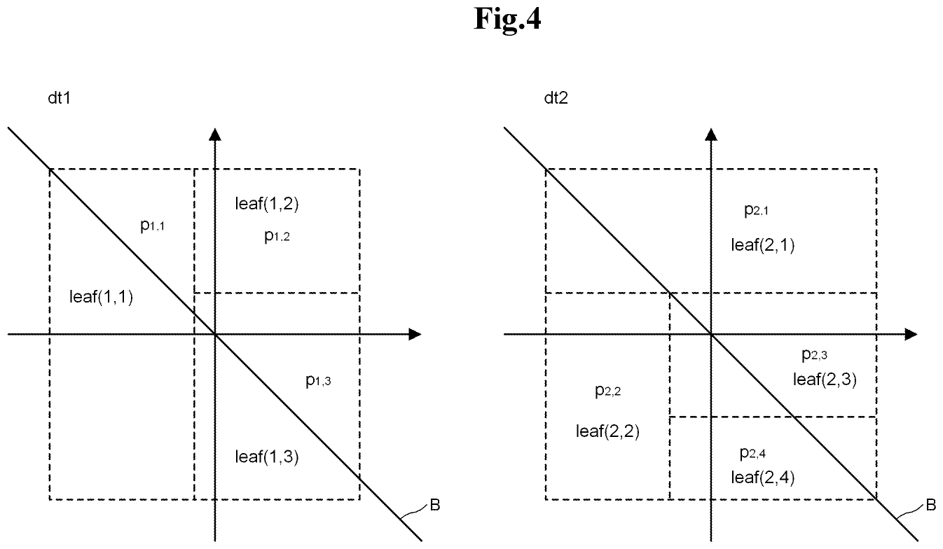

Further, FIG. 4 shows another example of division of the input space of the machine learning model by the region dividing unit 12. The left diagram of FIG. 4 shows the input space of the machine learning model dt1, and symbol B indicates the decision boundary. In a case where the machine learning model dt1 has three leaf nodes, the region dividing unit 12 divides the input space into three division regions leaf(1,1), leaf(1,2), and leaf(1,3). The right diagram of FIG. 4 shows the input space of the machine learning model dt2, and symbol B indicates the decision boundary. In a case where the machine learning model dt2 has four leaf nodes, the region dividing unit 12 divides the input space into four division regions leaf(2,1), leaf(2,2), leaf(2,3), and leaf(2,4). In this manner, the region dividing unit 12 may divide the input space of the machine learning model into any number of division regions.

Further, the region dividing unit 12 assigns probabilities to the division regions set by dividing the input space in each of the machine learning models as described above. For example, in the example of FIG. 3 described above, the region dividing unit 12 assigns “probability p_{1,1}” to the leaf node, namely, the division region leaf(1,1) of the machine learning model dt1, and assigns “probability p_{1,2}” to the leaf node, namely, the division region leaf(1,2). Likewise, the region dividing unit 12 assigns “probability p_{2,1}” and “probability p_{2,2}” to the division regions leaf(2,1) and leaf(2,2) of the machine learning model dt2, respectively, and assigns “probability p_{3,1}” and “probability p_{3,2}” to the division regions leaf(3,1) and leaf(3,2) of the machine learning model dt3, respectively. Meanwhile, in the example of FIG. 4 described above, the region dividing unit 12 assigns “probability p_{1,1}” to the division region leaf (1,1) of the machine learning model dt1, assigns “probability p_{1,2}” to the division region leaf(1,2), and assigns “probability p_{1,3}” to the division region leaf(1,3). Likewise, the region dividing unit 12 assigns “probability p_{2,1}”, “probability p_{2,2}”, “probability p_{2,3}”, and “probability p_{2,4}” to the division regions leaf(2,1), leaf(2,2), leaf(2,3), and leaf(2,4) of the machine learning model dt2, respectively.

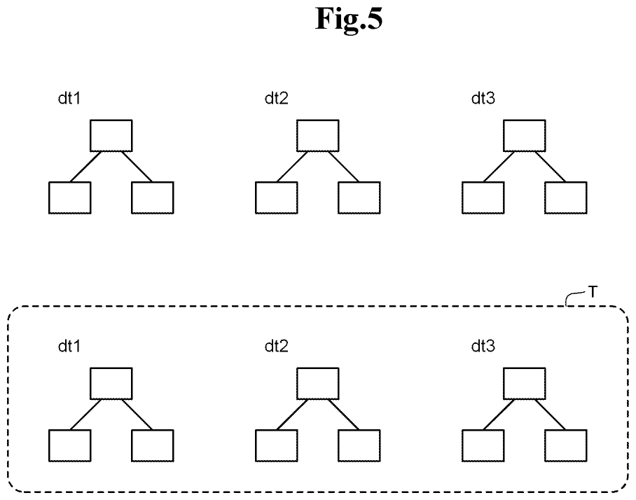

Here, an example of calculation of the probability assigned to the division region by the region dividing unit 12 stated above will be described. First, the region dividing unit 12 sets, as shown in the lower diagram of FIG. 5, an ensemble model T including a plurality of machine learning models dt1, dt2 and dt3 shown in the upper diagram of FIG. 5. Then, the region dividing unit 12 prepares an unlabeled data set U to be an input instance, inputs to the ensemble model T and to the respective machine learning models dt1, dt2 and dt3, and, based on the result of prediction by the ensemble model T and the results of prediction by the respective machine learning models dt1, dt2 and dt3, calculates a probability to be assigned to each of the division regions of the respective machine learning models dt1, dt2 and dt3 and assigns the probability to the division region. Specifically, the region dividing unit 12 regards a label with the highest prediction probability of the ensemble model T on the input instance as a correct label, and, based on the difference between the prediction probability to be the correct label by the ensemble model T on the input instance and the prediction probability in the division region, namely, the leaf node to be the correct label by each of the machine learning models dt1, dt2 and dt3 on the input instance, calculates a probability to be assigned to each of the division regions of the respective machine learning models dt1, dt2 and dt3. That is to say, the region dividing unit 12 evaluates the difference between the prediction probability of the ensemble model T and the predicted probability of each of the machine learning models dt1, dt2 and dt3 for each leaf node serving as the division region, and calculates the probability based on the result of evaluation. Below, an example of further specific processing will be described.

First, assuming that each machine learning model is dti (i is the number of models: i=1 to K), the prediction probability of each machine learning model is p_{dti}, and the label space is L, a set of unlabeled data to be input instances U will be considered. Here, assuming that a label predicted by the ensemble model T on an unlabeled input instance x∈U is yₑₙₛ (x), the probability that the ensemble model T predicts the label y is pₑₙₛ(y|x), and the probability that each machine learning model predicts the label y is pₐₜᵢ(y|x), they are expressed by the following equations 1 and 2, respectively.

$${p}_{ens} ( y \vert x ) = \frac{{\sum }_{i = 1}^{K} {p}_{dti} ( y \vert x )}{K} \qquad [ Equation 1 ]$$

$${y}_{ens} ( x ) = {argmax}_{y ∈ L} {p}_{ens} ( y \vert x ) \qquad [ Equation 2 ]$$

Then, assuming that the set of instances divided to leaf node j (leaf(i,j)) of the machine learning model dti in the input instances included by the data set U is U_{i,j} (U_{i,j}, j⊂U), the mean diff(i,j) of the difference in prediction probability in the leaf node j of the machine learning model dti is defined by the following equations 3 and 4.

$$diff ( i , j ) := {\sum }_{x ∈ {U}_{i , j}} \frac{{p}_{ens} ( {y}_{ens} ( x ) \vert x ) - {p}_{dti} ( {y}_{ens} ( x ) \vert x )}{\vert {U}_{i , j} \vert} \qquad [ Equation 3 ]$$

$${U}_{i , j} := \{ x ∈ U ⋂ leaf ( i , f ) \} \qquad [ Equation 4 ]$$

Then, diff(i,j) in Equation 3 is defined for each leaf node j of the respective machine learning models dti, and “probability p_{i,j}” of the leaf node j is defined by Equation 5, where the number of leaf nodes in total of the machine learning model dti is Nᵢ.

$${p}_{i , j} = \frac{diff ( i , j )}{{\sum }_{j = 1}^{{N}_{i}} diff ( i , j )} \qquad [ Equation 5 ]$$

Although a case where the region dividing unit 12 calculates a probability of each leaf node, namely, division region based on the difference in prediction probability between the ensemble model T and each machine learning model dti has been illustrated above, another machine learning model may be used instead of the ensemble model T. In this case, another machine learning model used instead of the ensemble model T is preferably a machine learning model with high prediction accuracy with respect to a predetermined instance generated in advance.

Further, the method of calculating the probability of each division region by the region dividing unit 12 described above is an example, and a probability may be assigned to each division region by any method. For example, the region dividing unit 12 may assign a value by a preset calculation equation or any value to each division region.

The probability calculating unit 13 calculates the sampling probability of an unlabeled input instance D2 when the input instance D2 is input to each of the machine learning models dt1, dt2 and dt3 as indicated by symbol S2 in FIG. 2, based on the probabilities assigned to the division regions of the respective machine learning models dt1, dt2 and dt3 as described above. Here, the probability calculating unit 13 calculates the sampling probability of the input instance D2 based on the probabilities assigned to the division regions to which the input instance D2 belongs in the respective machine learning models dt1, dt2 and dt3.

Here, assuming that the input instance is an unlabeled input instance x∈U and that the input instance x belongs to leaf nodes leaf(1,1), leaf(2,1) and leaf(3,1), which are the division regions of the respective machine learning models dt1, dt2 and dt3 shown in FIG. 3. In this case, the probability calculating unit 13 first calculates a sampling probability pᵢ(x) on the input instance x in each of the machine learning models dt1, dt2 and dt3 as indicated by Equation 6. Then, the probabilities in the respective machine learning models dt1, dt2 and dt3 on the input instance x are “probability p_{1,1}”, “probability p_{2,1}” and “probability p_{3,1}”.

pᵢ(x):=p(i,j)(if×∈leaf(i,j))(i=1, . . . ,K) [Equation 6]

Then, the probability calculating unit 13 calculates the mean value of the probabilities in the respective machine learning models dt1, dt2 and dt3 on the input instance x as indicated by Equation 7, specifically, Equation 8.

$$score ( x ) = \frac{{\sum }_{i = 1}^{K} {p}_{i} ( x )}{K} \qquad [ Equation 7 ]$$

$$score ( x ) = \frac{( {p}_{1 , 1} + {p}_{2 , 1} + {p}_{3 , 1} )}{3} \qquad [ Equation 8 ]$$

Furthermore, the probability calculating unit 13 normalizes the above mean value so that the sum of the probabilities becomes 1 as indicated by Equation 9 to calculate “sampling probability p(x)”.

$$p ( x ) = \frac{score ( x )}{{\sum }_{x ∈ U} score ( x )} \qquad [ Equation 9 ]$$

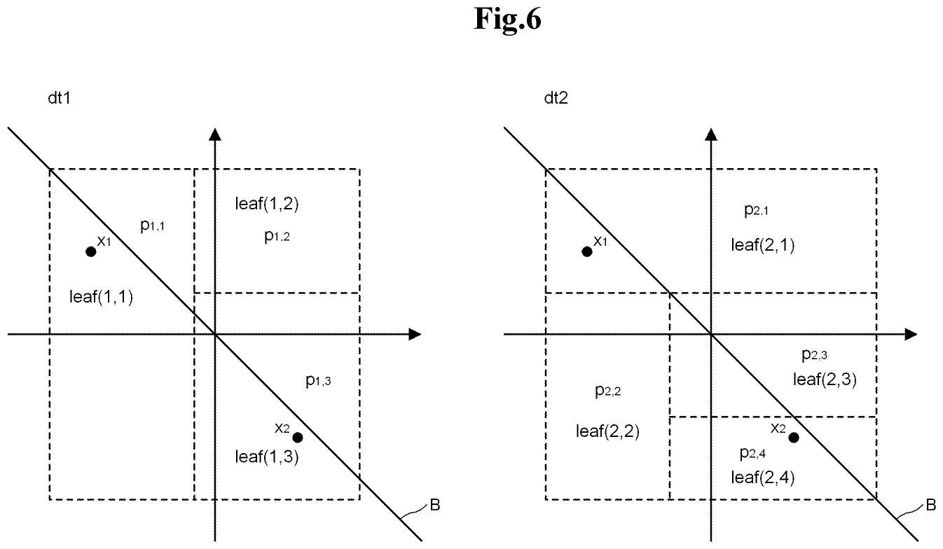

In the above description, the probability calculating unit 13 calculates the sampling probability by averaging the probabilities assigned to the plurality of division regions to which the input instance x belongs, but is not necessarily limited to calculating the sampling probability using the mean of the probabilities of the plurality of division regions. For example, the probability calculating unit 13 may assign weights based on a preset standard to the probabilities assigned to the plurality of division regions to which the input instance x belongs, and calculate the sampling probability by weighted mean. As another example, a case where input instances x1 and x2 belong to the division regions of the machine learning models dt1 and dt2, respectively, as shown in FIG. 6 will be considered. In this case, for the input instance x1, the probability calculating unit 13 may select one of the division regions to which the input instance x1 belongs, that is, the division region leaf(1,1) of the machine learning model dt1, and calculate the sampling probability using the probability p_{1,1}. Likewise, for the input instance x2, the probability calculating unit 13 may calculate the sampling probability using the probability p_{2,4} of one of the division regions to which the input instance x2 belongs, that is, the division region leaf(2,4) of the machine learning model dt2. Thus, the probability calculating unit 13 may calculate the sampling probabilities for the respective input instances using the probabilities assigned to the division regions of the machine learning models different from each other. In the above example, the probability calculating unit 13 may calculate the sampling probability of the input instance x1 as p_{1,1}/(p_{1,1}+p_{2,4}) and the sampling probability of the input instance x2 as p_{2,4}/(p_{1,1}+p_{2,4}) so that the sum of the probabilities becomes 1. Moreover, the probability calculating unit 13 is not limited to the examples described above, but may calculate the sampling probability of an input instance using the probability of any division region of any machine learning model.

The instance selecting unit 14 selects an input instance based on the sampling probabilities calculated for the input instances as described above. For example, the instance selecting unit 14 makes selection probability higher as the value of the sampling probability is higher, and selects such an input instance. Then, the instance selecting unit 14 inquires of an Oracle O about assignment of a label to the selected input instance as indicated by symbol S2 in FIG. 2. The Oracle O may be another machine learning model, or may be a human. Then, the instance selecting unit 14 stores an input instance D21 labeled by the oracle O into the selected instance storing unit 18.

The output unit 15 may output the labeled input instance D21 stored in the selected instance storing unit 18 to a user at any timing as indicated by symbol S3 in FIG. 2, or may output as the training instance D1 for training the machine learning model as indicated by symbol S4 in FIG. 2.

### [Operation]

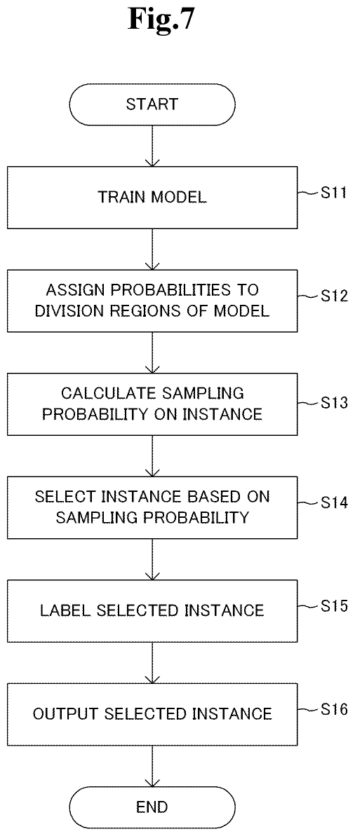

Next, the operation of the above information processing apparatus 10 will be described majorly with reference to a flowchart of FIG. 7.

First, the information processing apparatus 10 learns training instances previously provided with correct labels, and generates a plurality of machine learning models dt1, dt2 and dt3 (step S11). Meanwhile, the information processing apparatus 10 may store therein a plurality of machine learning models dt1, dt2 and dt3 generated in advance.

Next, for each of the plurality of machine learning models dt1, dt2 and dt3, the information processing apparatus 10 divides an input space for an instance to be the value of input to the machine learning model into a plurality of regions, and assigns probabilities to the respective division regions (step S12). For example, in a case where the machine learning model is formed of a decision tree shown in FIG. 3, the information processing apparatus 10 assigns probabilities to the respective division regions, which are equivalent to leaf nodes. The information processing apparatus 10 sets an ensemble model T including the plurality of machine learning models dt1, dt2 and dt3 as shown in FIG. 5, evaluates the difference between prediction by the ensemble model T and prediction by each of the machine learning models dt1, dt2 and d3 for each of the leaf nodes serving as the division regions, and assigns a probability calculated based on the evaluation result. Meanwhile, the information processing apparatus 10 may assign probabilities by any method to the division regions of the plurality of machine learning models dt1, dt2 and dt3.

Next, the information processing apparatus 10 calculates the sampling probability on an unlabeled input instance when the input instance is input to the respective machine learning models dt1, dt2 and dt3, based on the probabilities assigned to the division regions of the respective machine learning models dt1, dt2 and dt3 (step S13). The information processing apparatus 10 calculates the sampling probability on the input instance based on the probabilities assigned to the division regions to which the input instance belongs of the respective machine learning models dt1, dt2 and dt3. For example, the information processing apparatus 10 calculates, as the sampling probability, the mean value of the probabilities assigned to the division regions to which the input instance belongs of the respective machine learning models dt1, dt2 and dt3. Meanwhile, the information processing apparatus 10 may calculate the sampling probability by any method.

Next, the information processing apparatus 10 selects the input instance based on the sampling probabilities calculated on the input instance (step S14). For example, the information processing apparatus 10 makes selection probability higher as the value of the sampling frequency is higher, and selects the input instance. Then, the information processing apparatus 10 inquires of the oracle O about assignment of a label to the selected input instance, and stores the labeled input instance into the selected instance storing unit 18 (step S15).

After that, the information processing apparatus 10 outputs the selected and labeled input instance to the user at any timing, or outputs as a training instance D1 for training the machine learning model.

As described above, the information processing apparatus 10 in this example embodiment sets a plurality of division spaces in each of a plurality of machine learning models dt1, dt2 and dt3, assigns probabilities to the respective division spaces, and then calculates a sampling probability on a predetermined instance using the probabilities assigned to the respective division spaces. Therefore, by selecting instances based on such sampling probabilities, it is possible to suppress the selected instances from being biased in the input space of the machine learning model, and increase the accuracy of the machine learning model in the case of using as a training instance later.

In particular, in this example embodiment, a higher probability is set to a division region where the difference in prediction probability between another machine learning model such as an ensemble model and a plurality of machine learning models is larger, and the sampling probability of an input instance belonging to the division region is calculated higher. Therefore, the probability of selecting an instance with preferable training efficiency for the machine learning model increases, and the accuracy of the machine learning model can be further increased.

### Second Example Embodiment

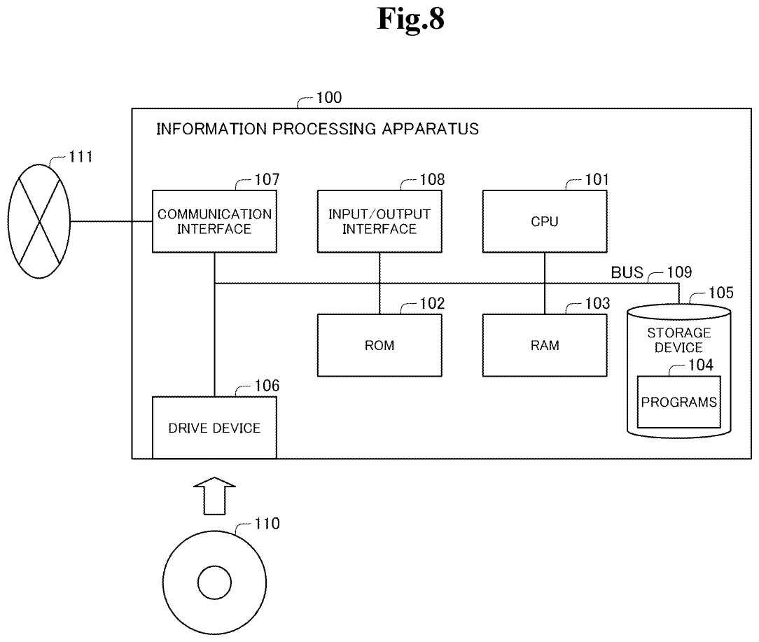

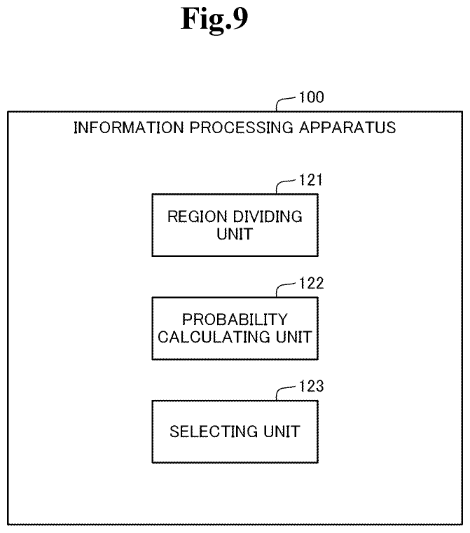

Next, a second example embodiment of the present disclosure will be described with reference to FIGS. 8 and 9. FIGS. 8 and 9 are block diagrams showing a configuration of an information processing apparatus in the second example embodiment. In this example embodiment, the overview of the configuration of the information processing apparatus described in the above example embodiment is shown.

First, a hardware configuration of an information processing apparatus 100 in this example embodiment will be described with reference to FIG. 8. The information processing apparatus 100 is formed of a general information processing apparatus and has, as an example, a hardware configuration as shown below including:
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 in which the programs 104 are stored,
a drive device 106 reading from and writing into a storage medium 110 outside the information processing apparatus,
a communication interface 107 connected to a communication network 111 outside the information processing apparatus,
an input/output interface 108 through which data is input and output, and
a bus 109 connecting the components.

FIG. 8 shows an example of the hardware configuration of the information processing apparatus serving as the information processing apparatus 100, and the hardware configuration of the information processing apparatus is not limited to the above case. For example, the information processing apparatus may include part of the above configuration, such as not having the drive device 106. Moreover, the information processing apparatus may use, instead of the above CPU, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, for example.

The information processing apparatus 100 can construct to be equipped with a region dividing unit 121, a probability calculating unit 122 and a selecting unit 123 shown in FIG. 9 by acquisition and execution of the programs 104 by the CPU 101. For example, the programs 104 are stored in the storage device 105 or the ROM 102 in advance, and is loaded into the RAM 103 and executed by the CPU 101 as necessary. The programs 104 may be supplied to the CPU 101 via the communication network 111, or may be stored in the storage medium 110 in advance and retrieved by the drive device 106 and supplied to the CPU 101. However, the region dividing unit 121, the probability calculating unit 122 and the selecting unit 123 described above may be constructed by dedicated electronic circuits for realizing such means.

The region dividing unit 121 divides an instance input space in each of a plurality of machine learning models into a plurality of regions, and assigns a probability to each of the division regions. For example, the region dividing unit 121 assigns a probability to each of the division regions based on the difference between the result of prediction on an input instance of another machine learning model and the result of the prediction of each of the plurality of machine learning models and, as an example, assigns a probability of larger value to a division region with a larger difference.

The probability calculating unit 122 calculates the sampling probability of a predetermined instance belonging to the division region based on the probability assigned to the division region. For example, the probability calculating unit 122 calculates the sampling probability on a predetermined instance using the probability assigned to the division region of each of the different machine learning models.

The instance selecting unit 123 selects a predetermined instance based on the sampling probability on the predetermined instance. After that, the selected instance can be labeled and output, and can be used as an instance for further training.

With the configuration as described above, the present disclosure sets a plurality of division spaces in each of a plurality of machine learning models, assigns a probability to each of the division spaces, and then calculates a sampling probability on a predetermined instance using the probability assigned to each of the division spaces. Therefore, by selecting instances based on the sampling probabilities, it is possible to suppress the selected instances from being biased in the input space of the machine learning model, and it is possible to increase the accuracy of the machine learning model when the selected instances are used as training instances later.

The program described above can be stored using various types of non-transitory computer-readable mediums and supplied to a computer. The non-transitory computer-readable mediums include various types of tangible storage mediums. Examples of the non-transitory computer-readable mediums include a magnetic recording medium (for example, a flexible disc, a magnetic tape, a hard disk drive), a magneto-optical recording medium (for example, a magneto-optical disc), a CD-ROM (Read Only Memory), a CD-R, a CD-R/W, and a semiconductor memory (for example, a mask ROM, a PROM (Programmable ROM), an EPROM (Erasable PROM), a flash ROM, a RAM (Random Access Memory)). The program may also be supplied to the computer by various types of transitory computer-readable mediums. Examples of the transitory computer-readable mediums include electrical signals, optical signals, and electromagnetic waves. The transitory computer-readable mediums can supply the program to the computer via wired channels such as wires and optical fibers, or via wireless channels.

Although the present disclosure has been described above with reference to the example embodiments and the like, the present disclosure is not limited to the above example embodiments. The configurations and details of the present disclosure can be changed in various manners that can be understood by one skilled in the art within the scope of the present disclosure. Moreover, at least one or more of the functions of the region dividing unit 121, the probability calculating unit 122, and the selecting unit 123 described above may be executed by an information processing apparatus installed and connected anywhere on the network, that is, may be executed by so-called cloud computing.

### <Supplementary Notes>

The whole or part of the example embodiments disclosed above can be described as the following supplementary notes. Below, the overview of configurations of an information processing apparatus, an information processing method, and a program in the present disclosure will be described. However, the present disclosure is not limited to the following configurations.

### (Supplementary Note 1)

An information processing apparatus comprising:
a region dividing unit configured to divide an instance input space of each of a plurality of machine learning models into a plurality of regions, and assign a probability to each of the division regions;
a probability calculating unit configured to calculate a sampling probability on a predetermined instance belonging to the division region based on the probability assigned to the division region; and
an instance selecting unit configured to select the predetermined instance based on the sampling probability on the predetermined instance.

### (Supplementary Note 2)

The information processing apparatus according to Supplementary Note 1, wherein the probability calculating unit is configured to calculate the sampling probability on the predetermined instance based on the probability assigned to the division region set for each of the machine learning models different from each other.

### (Supplementary Note 3)

The information processing apparatus according to Supplementary Note 1, wherein the probability calculating unit is configured to calculate the sampling probability on the predetermined instance based on the probabilities assigned to the division regions to which the identical predetermined instance belongs, the division regions being set for the respective machine learning models different from each other.

### (Supplementary Note 4)

The information processing apparatus according to Supplementary Note 1, wherein the region dividing unit is configured to assign the probabilities to the division regions of the plurality of machine learning models based on a result of prediction on an input instance by another machine learning model that is different from the plurality of machine learning models and results of prediction on the input instance by the respective machine learning models.

### (Supplementary Note 5)

The information processing apparatus according to Supplementary Note 4, wherein the region dividing unit is configured to assign the probabilities to the division regions of the plurality of machine learning models based on differences between a prediction probability in the division region set for the other machine learning model and prediction probabilities in the division regions set for the respective machine learning models.

### (Supplementary Note 6)

The information processing apparatus according to Supplementary Note 5, wherein the region dividing unit is configured to set so that values of the probabilities assigned to the division regions of the plurality of machine learning models become larger as the differences become larger.

### (Supplementary Note 7)

The information processing apparatus according to Supplementary Note 4, wherein the region dividing unit is configured to assign the probabilities to the division regions of the plurality of machine learning models based on a result of prediction on the input distance by the other machine learning model that is a new machine learning model generated based on the plurality of machine learning models and results of prediction on the input instance by the respective machine learning models.

### (Supplementary Note 8)

The information processing apparatus according to Supplementary Note 1, wherein the plurality of machine learning models are decision trees or decision lists.

### (Supplementary Note 9)

An information processing method comprising:
dividing an instance input space of each of a plurality of machine learning models into a plurality of regions and assigning a probability to each of the division regions;
calculating a sampling probability on a predetermined instance belonging to the division region based on the probability assigned to the division region; and
selecting the predetermined instance based on the sampling probability on the predetermined instance.

### (Supplementary Note 10)

A computer program comprising instructions for causing a computer to execute processes to:
divide an instance input space of each of a plurality of machine learning models into a plurality of regions, and assign a probability to each of the division regions;
calculate a sampling probability on a predetermined instance belonging to the division region based on the probability assigned to the division region; and
select the predetermined instance based on the sampling probability on the predetermined instance.

### DESCRIPTION OF NUMERALS

10 information processing apparatus
11 input unit
12 region dividing unit
13 probability calculating unit
14 instance selecting unit
15 output unit
16 instance storing unit
17 model storing unit
18 selected instance storing unit
100 information processing apparatus
101 CPU
102 ROM
103 RAM
104 programs
105 storage device
106 drive device
107 communication interface
108 input/output interface
109 bus
110 storage medium
111 communication network
121 region dividing unit
122 probability calculating unit
123 selecting unit

1. An information processing apparatus comprising:
at least one memory configured to store instructions; and
at least one processor configured to execute the instructions to:
divide an instance input space of each of a plurality of machine learning models into a plurality of regions, and assign a probability to each of the division regions;
calculate a sampling probability on a predetermined instance belonging to the division region based on the probability assigned to the division region; and
select the predetermined instance based on the sampling probability on the predetermined instance.

2. The information processing apparatus according to claim 1, wherein the processor is further configured to execute the instructions to
calculate the sampling probability on the predetermined instance based on the probability assigned to the division region set for each of the machine learning models different from each other.

3. The information processing apparatus according to claim 1, wherein the processor is further configured to execute the instructions to
calculate the sampling probability on the predetermined instance based on the probabilities assigned to the division regions to which the identical predetermined instance belongs, the division regions being set for the respective machine learning models different from each other.

4. The information processing apparatus according to claim 1, wherein the processor is further configured to execute the instructions to
assign the probabilities to the division regions of the plurality of machine learning models based on a result of prediction on an input instance by another machine learning model that is different from the plurality of machine learning models and results of prediction on the input instance by the respective machine learning models.

5. The information processing apparatus according to claim 4, wherein the processor is further configured to execute the instructions to
assign the probabilities to the division regions of the plurality of machine learning models based on differences between a prediction probability in the division region set for the other machine learning model and prediction probabilities in the division regions set for the respective machine learning models.

6. The information processing apparatus according to claim 5, wherein the processor is further configured to execute the instructions to
set so that values of the probabilities assigned to the division regions of the plurality of machine learning models become larger as the differences become larger.

7. The information processing apparatus according to claim 4, wherein the processor is further configured to execute the instructions to
assign the probabilities to the division regions of the plurality of machine learning models based on a result of prediction on the input distance by the other machine learning model that is a new machine learning model generated based on the plurality of machine learning models and results of prediction on the input instance by the respective machine learning models.

8. The information processing apparatus according to claim 1, wherein
the plurality of machine learning models are decision trees or decision lists.

9. An information processing method comprising:
dividing an instance input space of each of a plurality of machine learning models into a plurality of regions and assigning a probability to each of the division regions;
calculating a sampling probability on a predetermined instance belonging to the division region based on the probability assigned to the division region; and
selecting the predetermined instance based on the sampling probability on the predetermined instance.

10. A non-transitory computer-readable storage medium having a program stored therein, the program comprising instructions for causing a computer to execute processes to:
divide an instance input space of each of a plurality of machine learning models into a plurality of regions, and assign a probability to each of the division regions;
calculate a sampling probability on a predetermined instance belonging to the division region based on the probability assigned to the division region; and
select the predetermined instance based on the sampling probability on the predetermined instance.
